(19) United States
(12) Patent Application Publication
(10) Pub. No.: US 2003/0061879 A1
(43) Pub. Date: Apr. 3, 2003

(54) Variable speed fan motor equipped with abnormal rotational speed detection means

(76) Inventor: Motoi Otsuka, Kiryu-shi (JP)

Correspondence Address: BIRCH STEWART KOLASCH & BIRCH, PO BOX 747, FALLS CHURCH, VA, 22040-0747, US

(21) Appl. No.: 10/256,077

(22) Filed: Sep. 27, 2002

(30) Foreign Application Priority Data
Sep. 28, 2001 (JP) 2001-299109

(51) Int. Cl. G01P 3/44

(52) U.S. Cl. 73/514.39

(57) ABSTRACT

Abnormal rotational speed detection means of the variable speed fan motor according to the invention comprises a threshold width setting means that generates a threshold width set value of the rotational speed and a subtractor means that subtracts the threshold width set value from a rotational speed command value transmitted from a rotational speed command means. A value obtained by subtracting the threshold width set value from the rotational speed command value is put into a rotational speed comparator means as the threshold value for the rotational speed of the fan motor.

### BACKGROUND OF THE INVENTION

1. Field of the Invention

The present invention concerns a variable speed fan motor. More particularly, the present invention concerns a variable speed fan motor equipped with abnormal rotational speed detection means.

2. Description of the Prior Art

Most electronic equipments containing heat emitting components are provided with fan motors for cooling.

In general, the fan motor comprises a stator on which stator windings are provided, a rotor composed of a permanent magnet rotatably supported and opposing to the stator with a gap between, and a fan attached to the rotor.

Rotational speed of the fan motor is controlled by a drive circuit.

The drive circuit in general comprises; a Hall device for detecting the magnetic pole position of the permanent magnet, a rotational speed command circuit for commanding the rotational speed of the rotor, an excitation signal generator that receives the output of the Hall device and the output of the rotational speed command circuit and generates excitation signals, and a switching circuit that receives the excitation signals from the excitation signal generator and feeds currents to the stator windings.

Thus, the fan motor is rotated at the rotational speed according to the rotational speed command value transmitted from the rotational speed command circuit.

However, in case that the rotational speed of the fan motor is lowered by some cause, the cooling of the electronic equipment provided with the fan motor may become insufficient and functions of the electronic equipment may be adversely affected.

In order to prevent the insufficient cooling, there is provided an abnormal rotational speed detector that detects an abnormal lowering of the rotational speed of the fan motor and transmits a warning signal. The abnormal rotational speed detector comprises; a rotational speed sensor for detecting the current rotational speed of the fan motor, a threshold value generator for generating a predetermined threshold value that is a lower limit of the rotational speed over which the fan motor is judged to be running normally, and a rotational speed comparator circuit that compares the current rotational speed of the fan motor with the threshold value and transmits a warning signal from a warning output terminal when the current rotational speed of the fan motor is lower than the threshold value.

Thus, when the rotational speed of the fan motor is lowered than the threshold value by some cause, the warning signal is transmitted from the abnormal rotational speed detector, and it is possible to take a measure for preventing an accident caused by the lowering of the rotational speed of the fan motor.

However, as stated above, the fan motor can be rotated in general at a rotational speed according to the rotational speed command value, and the fan motor may be rotated at a rotational speed even lower than the threshold value at the lower side of the rotational speed. In this case, there is a problem that the warning signal is raised even though the fan motor is rotating at a desired rotational speed according to the rotational speed command value.

Further, there is a case in which cooling demanded by the electronic equipments is large and the fan motor needs to be rotated at a higher rotational speed than usual. In this case, there is a problem that the warning signal is not raised even though the rotational speed of the fan motor is lowered than the required rotational speed if the rotational speed is higher than the threshold value at the lower side of the rotational speed, and that it is not possible to take a measure for preventing an accident caused by the lowering of the rotational speed of the fan motor.

### SUMMARY OF THE INVENTION

It is an object of the present invention to solve the above problems and to provide a variable speed fan motor equipped with abnormal rotational speed detection means capable of setting a safe threshold value even when the rotational speed command value is varied.

In order to achieve the above object, the present invention provides a variable speed fan motor equipped with abnormal rotational speed detection means comprising;

a fan motor comprising a stator on which stator windings are provided, a rotor composed of a permanent magnet rotatably supported and opposing to the stator with a gap between, and a fan attached to the rotor,

a magnetic pole position detection means for detecting the magnetic pole position of the permanent magnet,

a rotational speed command means for commanding the rotational speed of the fan motor,

an excitation signal generator means that receives the output of the magnetic pole position detection means and the output of the rotational speed command means, and transmits excitation signals,

a winding current feeding means that receives the excitation signals from the excitation signal generator means, and feeds currents to the stator windings,

a rotational speed sensor means that detects the current rotational speed of the fan motor, and

a rotational speed comparator means that compares the current rotational speed of the fan motor with a threshold value at the lower side of the rotational speed and having a warning signal output terminal from which a warning signal is transmitted when the current rotational speed is lower than the threshold value,

wherein a threshold width setting means that generates a threshold width set value of the rotational speed and a subtractor means that subtracts the threshold width set value from the rotational speed command value transmitted from the rotational speed command means are provided, and a value obtained by subtracting the threshold width set value from the rotational speed command value is put into the rotational speed comparator means as the threshold value.

In the variable speed fan motor equipped with abnormal rotational speed detection means according to the present invention as stated above, the value obtained by subtracting the threshold width set value from the rotational speed command value is put into the rotational speed comparator means as the threshold value. Accordingly, it is possible to set a safe threshold value even when the rotational speed command value is varied, and to take a measure for preventing an accident caused by lowering of the rotational speed of the fan motor.

### BRIEF DESCRIPTION OF THE DRAWINGS

FIG. 1(a) is a block diagram showing a construction of the first embodiment of the variable speed fan motor equipped with abnormal rotational speed detection means according to the present invention.

FIG. 1(b) is a graph showing the relation between the rotational speed command value and the threshold value.

FIG. 2 is a block diagram showing a construction of the second embodiment of the variable speed fan motor equipped with abnormal rotational speed detection means according to the present invention.

FIG. 3 is a flow chart showing a flow of processes concerning an abnormal rotational speed detection in a microcomputer in FIG. 2.

### DETAILED DESCRIPTION OF THE INVENTION

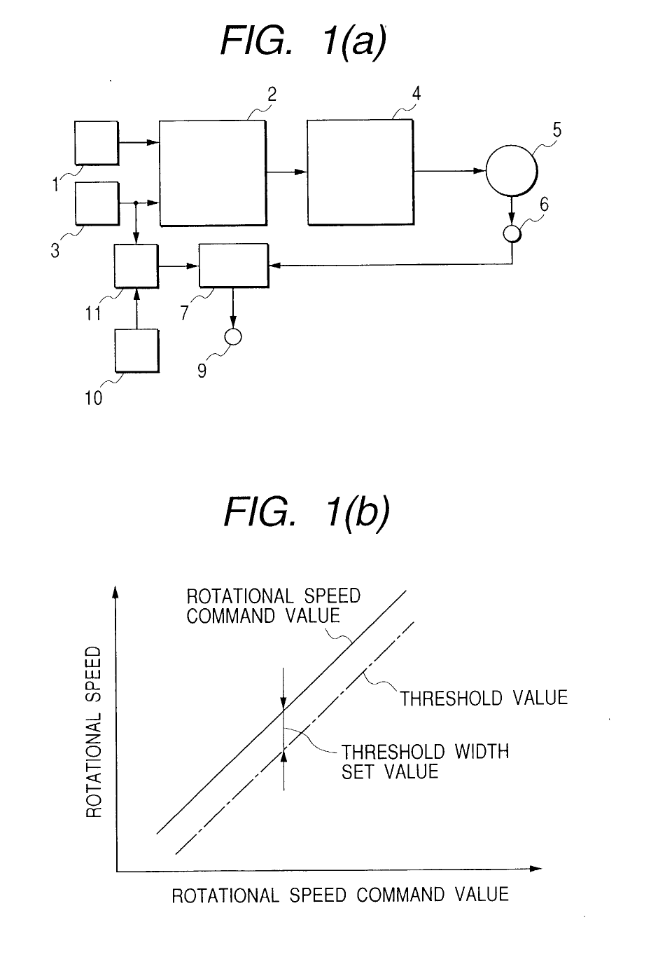

FIG. 1(a) shows a block diagram of the first embodiment of the variable speed fan motor equipped with abnormal rotational speed detection means according to the present invention.

The variable speed fan motor equipped with abnormal rotational speed detection means comprises; a Hall device 1 that is a magnetic pole position detection means for detecting the magnetic pole position of the permanent magnet of the rotor (not shown in the drawing) of the fun motor, a rotational speed command circuit 3 that is a rotational speed command means for commanding the rotational speed of the rotor, an excitation signal generator 2 that is an excitation signal generator means that receives the output of the Hall device 1 and the output of the rotational speed command circuit 3 and transmits excitation signals, and a switching circuit 4 that is a winding current feeding means that receives the excitation signals from the excitation signal generator 2 and feeds currents to the stator windings 5 of the fan motor.

Being thus constructed, the fan motor is rotated at the rotational speed according to the rotational speed command value given by the rotational speed command circuit 3.

The variable speed fan motor equipped with abnormal rotational speed detection means according to the present invention further comprises; a rotational speed sensor 6 that is a rotational speed sensor means for detecting the current rotational speed of the fan motor, a threshold width setting circuit 10 that is a threshold width setting means, a subtractor 11 that is a subtractor means, a rotational speed comparator 7 that is a rotational speed comparator means having a warning signal output terminal 9. An input terminal of the subtractor 11 is connected to an output terminal of the rotational speed command circuit 3, whereas another input terminal of the subtractor 11 is connected to an output terminal of the threshold width setting circuit 10. An output terminal of the subtractor 11 is connected to a threshold value input terminal of the rotational speed comparator 7. The rotational speed command circuit 3 generates the rotational speed command value. The threshold width setting circuit 10 generates a threshold width set value. The subtractor 11 subtracts the threshold width set value from the rotational speed command value, the result of which is put into the threshold value input terminal of the rotational speed comparator 7 as a threshold value of the lower side of the rotational speed of the fan motor. The rotational speed comparator 7 compares the threshold value with the current rotational speed of the fan motor that is an output of the rotational speed sensor 6, and transmits a warning signal from the warning signal output terminal 9 when the current rotational speed of the fan motor is lower than the threshold value.

Thus, the threshold value put into the rotational speed comparator 7 is lower than the rotational speed command value of the rotational speed command circuit 3 by the threshold width set value of the threshold width setting circuit 10. That is, the threshold value put into the rotational speed comparator 7 is set according to the rotational speed command value that is transmitted from the rotational speed command circuit 3.

FIG. 1(b) is a graph showing the relation between the rotational speed command value of the rotational speed command circuit 3 and the threshold value put into the rotational speed comparator 7. As shown in the graph, the threshold value put into the rotational speed comparator 7 is always lower than the rotational speed command value by the threshold width set value. Thus, it is possible to set a safe threshold value even when the rotational speed command value is varied. Accordingly, when the rotational speed of the fan motor is lowered in certain amount than the desired rotational speed by some cause, a warning signal is transmitted from the abnormal rotational speed detection means regardless of the fan motor being rotated at a lower rotational speed than usual or at a higher rotational speed than usual, and it is possible to take a measure for preventing an accident caused by the lowering of the rotational speed of the fan motor.

In the first embodiment of the variable speed fan motor equipped with abnormal rotational speed detection means according to the present invention as shown in FIG. 1(a), the system is constructed by connecting ordinary parts for electric circuits. Accordingly, the system is comprehensive and easy for ascertaining its operation. However, the system is comparatively large in size.

In the second embodiment of the variable speed fan motor equipped with abnormal rotational speed detection means according to the present invention, a microcomputer is adopted to make the system compact, and the excitation signal generator means, the comparator means and the subtractor means are contained in the microcomputer. By operating the microcomputer with an appropriate predetermined program, control similar to that of the first embodiment can be achieved. Since composing elements other than the excitation signal generator means, the comparator means and the subtractor means are the same to those in the first embodiment, explanations for these elements are omitted.

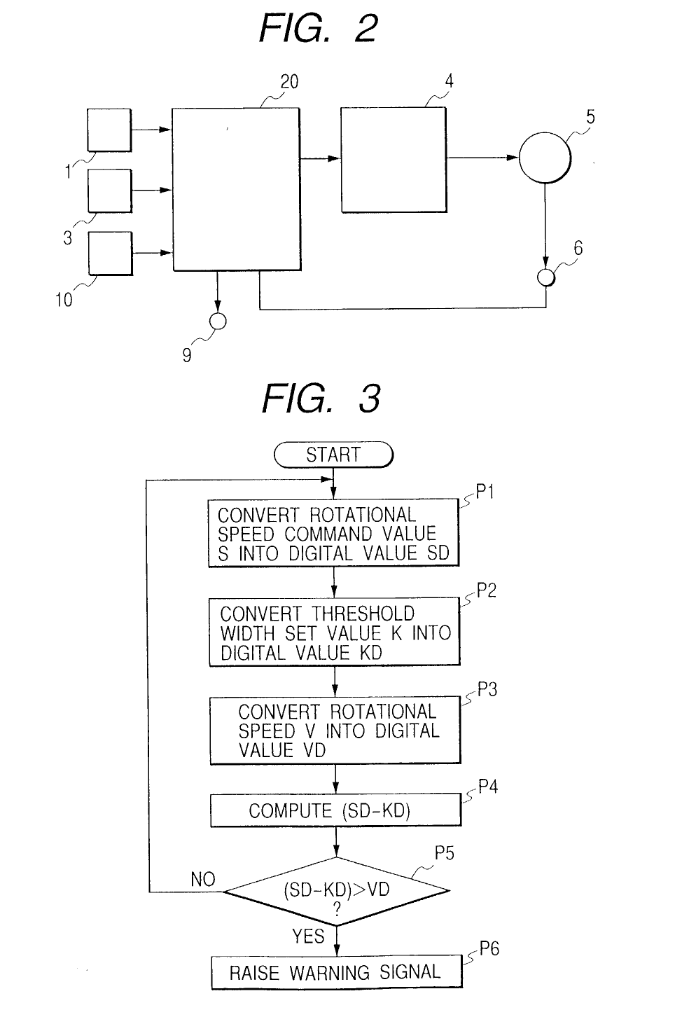

FIG. 2 is a block diagram showing a construction of the second embodiment of the variable speed fan motor equipped with abnormal rotational speed detection means according to the present invention. The microcomputer 20 receives an output of a Hall device 1 and a rotational speed command value from a rotational speed command circuit 3, and transmits excitation signals to a switching circuit 4. The microcomputer 20 also receives a rotational speed command value from a rotational speed command circuit 3 and a threshold width set value from a threshold width setting circuit 10, subtracts the threshold width set value from the rotational speed command value, and compares the resulting value with a current rotational speed that is an output of a rotational speed sensor 6. If the current rotational speed is lower than the resulting value obtained by subtracting the threshold width set value from the rotational speed command value, then the microcomputer 20 transmits a warning signal from a warning signal output terminal 9.

FIG. 3 is a flow chart showing a flow of a program in the microcomputer 20 in FIG. 2. The program processes the rotational speed command value S, the threshold width set value K and the current rotational speed V, and transmits a warning signal if necessary. In FIG. 3, P1 to P6 are steps in the flow.

In the step P1, the rotational speed command value S received from the rotational speed command circuit 3 is converted into a digital value SD.

In the step P2, the threshold width set value K received from the threshold width setting circuit 10 is converted into a digital value KD.

In the step P3, the current rotational speed V received from the rotational speed sensor 6 is converted into a digital value VD.

In the step P4, the digital value KD is subtracted from the digital value SD to obtain a digital value (SD−KD).

In the step P5, the digital value (SD−KD) is compared with the digital value VD. If (SD−KD)>VD, then an exit YES is chosen and the flow proceeds into the step P6.

The step P6 causes the warning signal to be raised.

In the step P5, if (SD−KD)≦VD, then an exit NO is chosen and the flow returns back into the step P1 to repeat the flow as explained above.

In the second embodiment of the variable speed fan motor equipped with abnormal rotational speed detection means according to the present invention, the excitation signal generator means, the comparator means and the subtractor means are contained in the microcomputer 20, and the microcomputer 20 is operated with the predetermined program. Accordingly, the system can be made compact and the control similar to that of the first embodiment can be achieved. Also, same to the first embodiment, it is possible to set a safe threshold value even when the rotational speed command value is varied. Accordingly, when the rotational speed of the fan motor is lowered than the desired rotational speed by some cause, the warning signal is transmitted from the abnormal rotational speed detection means regardless of the fan motor being rotated at a lower rotational speed than usual or at a higher rotational speed than usual, and it is possible to take a measure for preventing an accident caused by the lowering of the rotational speed of the fan motor.

Additionally, as stated above, the threshold width setting circuit sets the threshold width set value for setting the lower side threshold value of the rotational speed according to the rotational speed command value. However, since the threshold width set value itself can be set independently of the rotational speed command value, the distance between the rotational speed command value and the threshold value is kept in a desired value even when the rotational speed command value is varied.

What is claimed is:

1. A variable speed fan motor equipped with abnormal rotational speed detection means comprising;
a fan motor comprising a stator on which stator windings are provided, a rotor composed of a permanent magnet rotatably supported and opposing to said stator with a gap between, and a fan attached to said rotor,
a magnetic pole position detection means for detecting the magnetic pole position of said permanent magnet,
a rotational speed command means for commanding the rotational speed of said fan motor,
an excitation signal generator means that receives the output of said magnetic pole position detection means and the output of said rotational speed command means, and transmits excitation signals,
a winding current feeding means that receives said excitation signals from said excitation signal generator means, and feeds currents to said stator windings,
a rotational speed sensor means that detects the current rotational speed of said fan motor, and
a rotational speed comparator means that compares said current rotational speed of said fan motor with a threshold value at the lower side of the rotational speed and having a warning signal output terminal from which a warning signal is transmitted when said current rotational speed is lower than said threshold value,
wherein a threshold width setting means that generates a threshold width set value of said rotational speed and a subtractor means that subtracts said threshold width set value from the rotational speed command value transmitted from said rotational speed command means are provided, and a value obtained by subtracting said threshold width set value from said rotational speed command value is put into said rotational speed comparator means as said threshold value.

2. The variable speed fan motor equipped with abnormal rotational speed detection means according to claim 1, wherein;
said magnetic pole position detection means comprises a Hall device,
said rotational speed command means comprises a rotational speed command circuit that generates said rotational speed command value,
said excitation signal generator means comprises an excitation signal generator that receives the output of said Hall device and said rotational speed command value, and transmits said excitation signals,
said winding current feeding means comprises a switching circuit that receives said excitation signals and feeds said currents to said stator windings,
said rotational speed sensor means comprises a rotational speed sensor that detects said current rotational speed of said fan motor,
said rotational speed comparator means comprises a rotational speed comparator that compares said current rotational speed with said threshold value,
said threshold width setting means comprises a threshold width setting circuit that generates said threshold width set value, and
said subtractor means comprises a subtractor that subtracts said threshold width set value from said rotational speed command value.

3. The variable speed fan motor equipped with abnormal rotational speed detection means according to claim 1, wherein;
said magnetic pole position detection means comprises a Hall device,
said rotational speed command means comprises a rotational speed command circuit that generates said rotational speed command value,
said winding current feeding means comprises a switching circuit that receives said excitation signals and feeds said currents to said stator windings,
said rotational speed sensor means comprises a rotational speed sensor that detects said current rotational speed of said fan motor,
said threshold width setting means comprises a threshold width setting circuit that generates said threshold width set value,
said excitation signal generator means, said rotational speed comparator means and said subtractor means are contained in a microcomputer,
said microcomputer is operated with a predetermined program, and
said microcomputer receives the output of said Hall device and said rotational speed command value, transmits said excitation signals, subtracts said threshold width set value from said rotational speed command value, compares the value obtained by subtracting said threshold width set value from said rotational speed command value with said current rotational speed, and raises said warning signal when said current rotational speed is lower than said value obtained by subtracting said threshold width set value from said rotational speed command value.
